(19) United States
(12) Patent Application Publication
(10) Pub. No.: US 2018/0126830 A1
(43) Pub. Date: May 10, 2018

(54) Cargo Containment Structure Double Swing Door System

(71) Applicant: Ursa Major Corporation, Waukesha, WI (US)

(72) Inventor: John B. Lampsa, Wales, WI (US)

(73) Assignee: Ursa Major Corporation, Waukesha, WI (US)

(21) Appl. No.: 15/809,533

(22) Filed: Nov. 10, 2017

Related U.S. Application Data
(60) Provisional application No. 62/420,166, filed on Nov. 10, 2016.

(51) Int. Cl. B60J 5/10; E05D 3/12; E05D 3/08; E05B 83/08

(52) U.S. Cl. CPC B60J 5/108; E05D 3/127; E05Y 2900/516; E05B 83/08; E05D 3/08

(57) ABSTRACT

A cargo containment structure swinging door system having one or more doors capable of swinging on double pivoting hinges such that said door or doors can be opened both outward of the cargo containment structure and inward into the cargo containment structure. The doors are capable of being secured by a latching mechanism in a closed position. The cargo containment structure may be a semi-trailer, cargo shipping container or straight van body of a cargo carrying truck.

### RELATED APPLICATION

This application claims the benefit of co-pending U.S. Provisional Patent Application Ser. No. 62/420,166, filed 10 Nov. 2016.

### BACKGROUND OF THE INVENTION

The present invention pertains to the functionality of the door or doors found on a cargo containment structure such as on a semi-trailer or cargo container. Semi-trailers are typically used to haul cargo from one location to another. The trailer is typically coupled to a semi-truck when moved from one location to another. The present invention may also pertain to the functionality of the door or doors on a straight van body style truck or cargo container attached to a semi-trailer as well.

A semi-trailer has one or more doors located on the back side of the trailer. A straight van body style truck and cargo container may have the same door configuration. In transit, the door or doors are closed. The doors are opened when cargo is placed in to or removed from the trailer, truck or container.

There are two common styles of doors used on semi-trailers and straight van body style trucks. The first is a roll-up door comprised of multiple horizontal door segments that are hingedly attached to one another along their upper and lower edges. This type of door is guided by rollers on its outward left and right edges. The rollers fit within tracks attached to the sides and roof of the semi-trailer adjacent and above its rear opening. When opened, the door moves upward and curves along its hinged segments as it bends from a generally vertical position to a generally horizontal position in the ceiling of the trailer (substantially parallel with the trailer roof). The second style door is a swinging door, also sometimes referred to as a barn door. A semi-trailer typically has two swinging doors, although only one door could be used in some applications. Each swinging door is hingedly attached to the vertical edge of the trailer's back side and the pair of doors meet at the center of the back side. In a single door application, the single door extends from one vertical edge of the trailer's back side to the opposite vertical edge. The present invention is an improvement to the swinging or barn style door configuration.

Known swinging semi-truck trailer and cargo container doors swing only outward from the back side of the trailer or container through an arc of almost 270 degrees and then rest against, or are temporarily fastened to, the outer sides of the semi-trailer or cargo container. The hinges used on each door, as well as structural elements of the trailer's construction prevent the doors from swinging inward into the interior of the trailer. The same holds true for a cargo container.

Because a sufficient amount of space is required behind and next to the trailer to open each swinging door, the trailer doors must be opened before the trailer is positioned at a loading dock. Through the use of leveling devices, the heights of most loading docks are adjusted to be at substantially the same level as the trailer floor. This allows the use of wheeled equipment, such as fork lift trucks and dollies, to be driven from the dock into the trailer to load or unload cargo. In addition, loading docks are often spaced one right next to the other with a minimal amount of space between parked semi-trailers. Once the semi-trailer is positioned at the dock, there is insufficient clearance for the swinging doors to be opened or closed.

When the semi-trailer is ready to be loaded or unloaded with cargo, the trailer is backed against a loading dock. Before the truck driver positions the trailer against the dock, the driver must first open the semi-trailer doors. At present, the driver must stop the semi-truck in an area away from the loading dock, get out of the truck cab, open (and secure) each trailer door, get back in the cab and then back the trailer into position at the loading dock. Similarly, once the trailer has been filed with cargo, the driver must pull away from the loading dock, get out of the truck cab, close and secure the trailer doors and get back in the cab.

There is a need for a semi-trailer door other than a roll-up style door that can be opened and/or closed after the trailer is positioned at the loading dock. Roll-up style doors require a significant amount of maintenance, require a bending motion for opening and a reaching motion for closing that can cause injury to the operator and have a low header clearance due to the door tensioner and door storage requirements when the door is open.

There is a need for a semi-trailer door where someone other than the driver can open and close the semi-trailer door.

There is need for a semi-trailer door that can be secured in its closed position before the semi-truck and trailer leave the loading dock.

There is a need for a semi-trailer door that does not require a truck driver to exit the truck to open or close the trailer door before backing the trailer into the docking area.

Similar needs exist for cargo container's as well, especially cargo containers that are attached to semi-trailers for the pick-up and delivery of goods.

### SUMMARY OF THE INVENTION

The present invention comprises a swinging door system for a cargo containment structure having one or more swinging or barn doors capable of swinging both outward of the cargo containment structure and inward into the cargo containment structure. The doors are capable of being secured by a latching mechanism in a closed position.

The cargo containment structure comprises a door frame, which is provided by at least two side walls of the cargo containment structure and an associated framing. At least one door is in communication with the door frame. At least two double hinges are in coupled communication with each of at least one door and the door frame. The double hinges comprise a first pivot point and a second pivot point, whereby the at least one door can be opened into or out of the cargo containment structure.

The door system of the present invention further comprises a pair of swinging or barn doors, two or more double hinges coupled between each door and the cargo containment structure and a locking mechanism.

In a preferred embodiment, the door system of the present invention comprises a pair of semi-truck trailer swinging or barn doors, two or more double hinges coupled between each door and the trailer and a locking mechanism.

In another preferred embodiment, the door system of the present invention comprises a pair of cargo container swinging or barn doors, two or more double hinges coupled between each door and the container and a locking mechanism.

The back side of a cargo containment structure has a rectangular shaped opening formed by its side walls, floor and roof. The side walls and their associated framing allow for the mounting of two or more first hinge plates along each vertical side of the opening. Mating, second, hinge plates are mounted to each swinging door. A pivot plate (or pair of pivot plates) is positioned between the hinge plates. When hinge pins are placed into the mating openings between each hinge plate and pivot plate, each swinging door is hingedly supported on the back side of the cargo containment structure. Specifically, at least one first hinge pin is in arranged communication with each of the at least two first hinge plates and the at least one pivot plate. Further, at least one second hinge pin is in arranged communication with each of the at least two second hinge plates and the at least one pivot plate. The construction and utilization of each hinge allows the cargo containment structure door to swing outwardly or inwardly relative to the opening in the rear side of the cargo containment structure.

As described above, the present invention utilizes double hinges. Each double hinge is mounted to the cargo containment structure opening and to each door. Unlike a traditional hinge with a single pivot point, each double hinge includes a fist pivot point and a second pivot point. The first and second pivot points allow the swinging door to pivot about the first pivot and second points when opened in the outward direction and pivot about the first pivot point when opened in the inward direction.

### BRIEF DESCRIPTION OF THE DRAWINGS

FIG. 1 is a perspective view of a rear portion of a semi-trailer including the double swing door system;

FIG. 2 is a rear elevation view of a semi-trailer including the double swing door system;

FIG. 3 is a perspective view of the latch mechanism shown in FIG. 1;

FIG. 4 is a cut-away top plan view of a semi-trailer including the double swing door system with the doors closed;

FIG. 4A is an enlarged view of the semi-trailer door hinge system of FIG. 4;

FIG. 5 is a cut-away top plan view of a semi-trailer including the double swing door system with the doors partially open outwardly;

FIG. 6 is a cut-away top plan view of a semi-trailer including the double swing door system with the doors fully open outwardly;

FIG. 6A is an enlarged view of the semi-trailer door hinge system of FIG. 6;

FIG. 7 is a an enlarged view of the semi-trailer including the double swing door system with the doors fully open inwardly;

FIG. 7A is an enlarged view of the semi-trailer door hinge system of FIG. 7; and

FIG. 8 is a rear elevation view of a semi-trailer similar to FIG. 2, but depicting an alternate latch mechanism.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

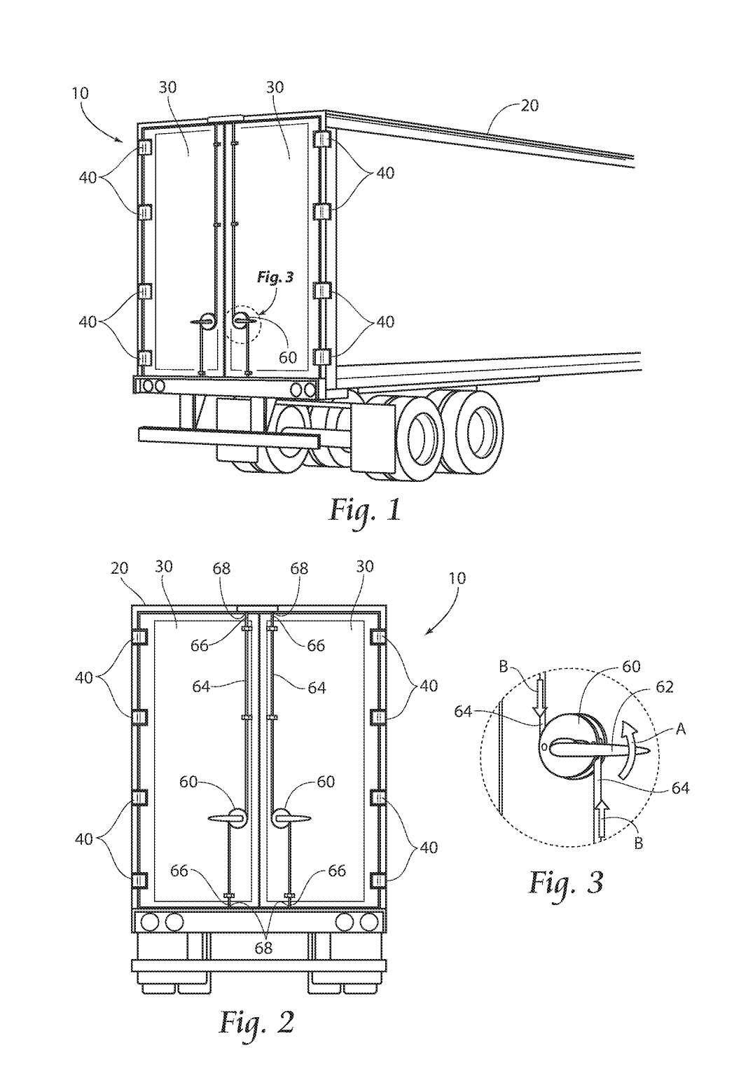

FIGS. 1 and 2 depict a semi-trailer 20 of the type to which the present invention 10 is applicable. It is to be understood and appreciated that the invention 10 has numerous applications to other types of truck trailers, to cargo containers, to straight van body style trucks, to refrigerated trailers and truck bodies, etc. As shown in FIG. 1, a pair of doors 30 are hingedly supported on a plurality of two-way hinges 40. While four hinges are shown, the number could be greater or less, depending upon the specific application.

Now referring to FIGS. 1-3, the invention 10 further includes one or more latching mechanisms 60 for securing each door 30 in a closed position. Referring specifically to FIG. 3, rotation of the latch mechanism handle 62 in the direction shown by the arrow A moves locking bars 64 in the direction shown by arrows B thereby disengaging the ends 66 of locking bars 64 from their locking openings 68 (best shown FIGS. 5-7) thereby allowing each unlatched door 30 to swing in the desired direction. It is important to note that the desired direction can be either outwardly of the semi-trailer 20 or inwardly of the semi-trailer 20.

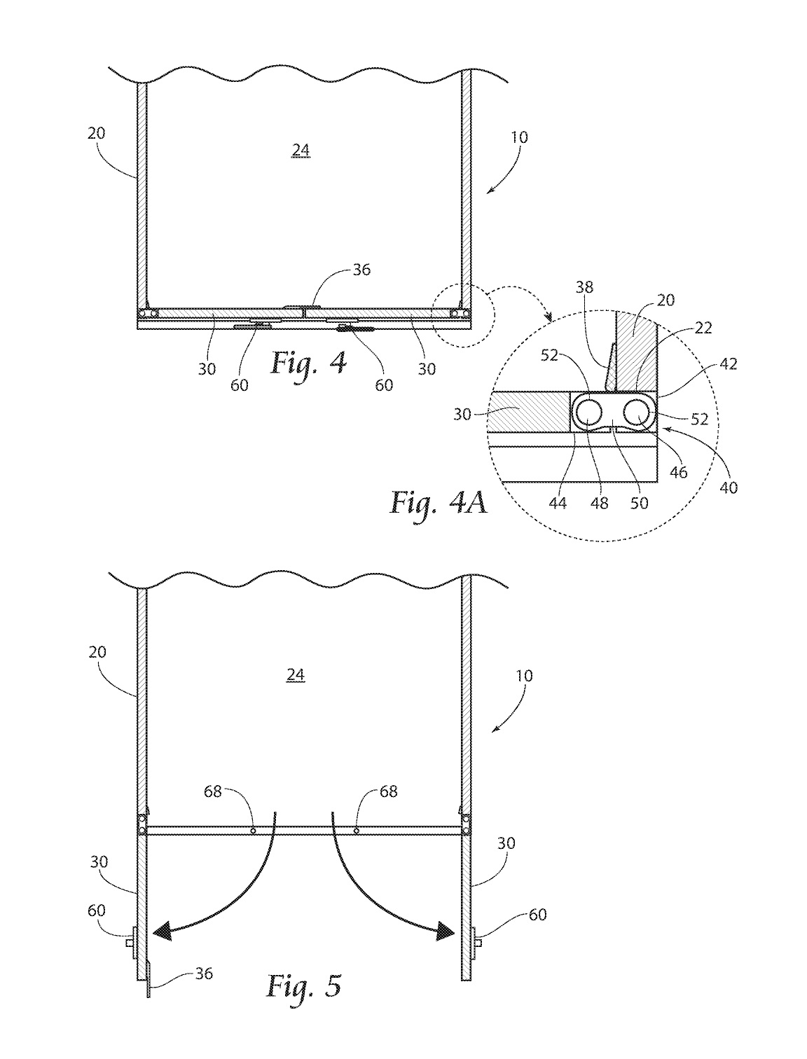

FIG. 4 is a cut-away top plan view of the trailer 20 and doors 30 in a closed position including the location of two-way hinges 40. FIG. 4A depicts a preferred embodiment of the two-way hinge 40. The two-way hinge 40 includes a first mounting plate 42, a second mounting plate 44, a first pivot pin 46, a second pivot point 48 and a pair of pivot plates 50. Each two-way hinge 40 has its first hinge mounting plate 42 attached to the semi-trailer door frame 22 and a second hinge mounting plate 44 attached to the edge of the swinging door 30. The pivot pins 46, 48 pass through pivot openings 52 in the pivot plates 50. A door seal 38 may also provided to prevent dust, dirt, debris or other foreign matter from entering into the trailer 20 cargo compartment 24 when the doors 30 are in their closed position.

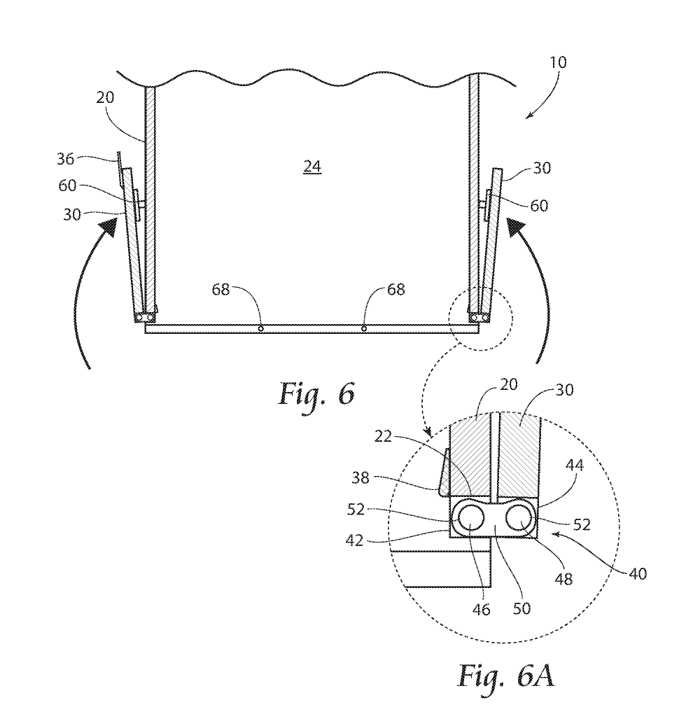

The doors 30 of the present invention can be opened in the traditional manner as shown in the cutaway top plan views of FIGS. 5 and 6. The doors 30 are swung outward of the trailer 20 to allow access to the trailer interior 24 via its back side. The doors 30 may be open partially (FIG. 5) or completely (FIG. 6). The position of the doors in FIG. 6 is the position required in the prior art when the trailer 20 is backed to a loading dock 70. The door position shown in FIG. 5 is not feasible as the position of the doors will not allow the trailer 20 to be positioned immediately adjacent to the loading dock such that wheeled equipment, such as dollies and fork lift trucks can be used to add or remove cargo from within the trailer 20.

As best shown in FIGS. 4, 5 and 6, it will also be noted that one of the doors 30 may include a stop plate 36 attached to its inner surface. The function of the stop plate 36 is to provide a stop surface and seal between the doors 30 in their closed and latched position (see FIG. 4). FIG. 6A depicts the position of the two-way hinge 40 when the doors 30 have been swung fully open, substantially parallel to the sides of the trailer 20 to their outwardly open position typically required before the trailer 20 is backed adjacent to a loading dock 70.

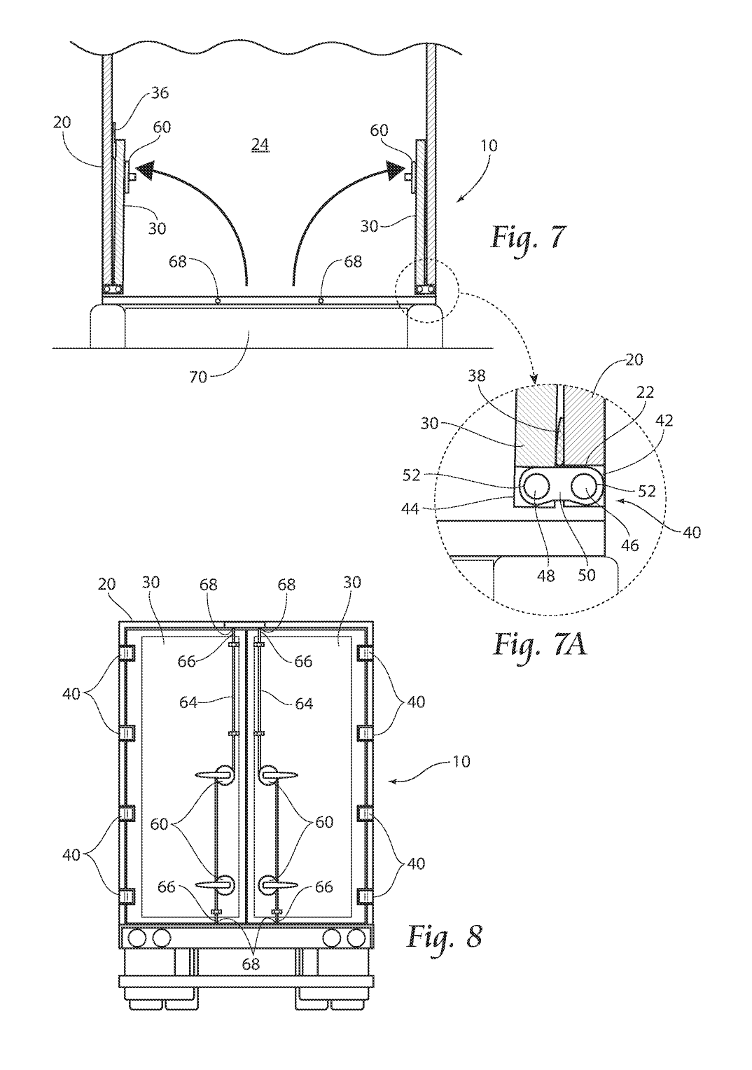

FIG. 7 shows each door 30 in its inwardly swung open position. Opening the doors 30 in this manner allows the driver of the semi-truck (not shown) to which the semi-trailer 20 is coupled the ability to back up to a loading dock 70 without having to first stop the truck, exit the truck, open the trailer doors 30 in the outward direction (as shown in FIG. 6), get back in the truck and finish backing the trailer 30 toward the loading dock 70. FIG. 7A depicts the hinge 40 position when the doors 30 are in their fully opened and inward swung position. Unlike the door positions shown in FIGS. 5 and 6, it is to be appreciated that even though the trailer 20 is positioned adjacent to the loading dock 70, it is still possible to open (and close) each semi-trailer door 30 by swinging it inwardly into the cargo area of the trailer (and then outwardly to the closed position) without the need to reposition or relocate the trailer relative to the loading dock 70.

One drawback of the present invention 10 may be the presence of cargo (not shown) in the interior 24 of the trailer 20 that may prevent the doors 30 from swinging in the inward direction shown in FIG. 7. In the case of a trailer 20 that is fully loaded or substantially fully loaded with cargo (often referred to as “cubed out”), the driver may have to open the doors 30 in the outwardly swinging direction at the first dock (or first few docks) where cargo is to be unloaded. Once a sufficient amount of cargo has been removed from the interior of the trailer 20, then the trailer doors 30 can be swung in the inward direction at the following docks to unload additional cargo.

Likewise, if an empty trailer 20 is being loaded with an amount of cargo that will not completely fill the trailer 20, the trailer may be backed to the loading dock 70 without the need for the driver to stop and open the trailer doors 30 prior to backing against the loading dock 70. The trailer doors 30 may be opened in the inward direction (as shown in FIG. 7) after the trailer 20 is positioned at the loading dock 70.

FIG. 8 is another rear elevation view of the back side of a semi-trailer 20 utilizing the present invention 10. An alternate or dual latching mechanism 60 is shown. The alternate mechanism provides a first or lower latching mechanism 60 on each trailer door 30 and a second or upper latching mechanism 60 on the same trailer door 30. The upper and lower latching mechanisms 60 allow for the driver to release or engage the door latch 60 utilizing the lower mechanism when standing on the ground and a dock worker to release or engage the door latch when standing on the loading dock. Neither trailer door operator (driver or dock worker) is thus required to reach over his or her head or stoop toward the ground to operate the latch mechanism 60. It has been shown that both of these motions can lead to potential injuries to the operator.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the claims.

I claim:

1. A door system for a cargo containment structure, said cargo containment structure having an interior, said door system comprising:
a door frame;
said door frame provided by at least one substantially vertical side wall of said cargo containment structure;
at least one door positioned within said door frame;
at least two double hinges in coupled communication with each of at least one door and said door frame;
said double hinges each having a first pivot point and a second pivot point; and
whereby said at least one door can be opened into said cargo containment structure interior or out of said cargo containment structure.

2. The door system claim 1 wherein two doors are positioned within said door frame.

3. The door system of claim 1 wherein a plurality of double hinges are in coupled communication with each of at least one door and said door frame.

4. The door system of claim 1 wherein said double hinge first pivot point and second pivot point are spaced sufficiently apart to allow said door to be opened fully within said cargo containment structure interior.

5. The door system of claim 1 wherein said at least one door is in hinged communication with said door frame about said first pivot point and said second pivot point; and whereby said at least one door opens out of said cargo containment structure.

6. The door system of claim 1 wherein said at least one door is in hinged communication with said door frame about said first pivot point and said second pivot point; and whereby said at least one door opens into said cargo containment structure interior.

7. The door system of claim 1 further comprising at least one latching mechanism coupled to said at least one door and engagable with said cargo containment structure.

8. The door system of claim 7 wherein each of said at least one latching mechanism further includes a locking bar positioned between said latching mechanism and said cargo containment structure.

9. The door system of claim 8 wherein each of said at least one latching mechanism further comprises at least one latch mechanism handle coupled to said latching mechanism; and
whereby rotation of said at least one latch mechanism handle moves said at least one locking bar.

10. The door system of claim 1 wherein each double hinge comprises a first hinge plate, a second hinge plate, and a pivot plate, said pivot plate pivotally coupled between said first hinge plate and said second hinge plate.

11. The door system of claim 10 wherein each double hinge further comprises a first hinge pin pivotally coupled between said fist hinge plate and said pivot plate.

12. The door system of claim 10 wherein each double hinge further comprises a second hinge pin pivotally coupled between said second hinge plate and said pivot plate.

13. The door system of claim 10 wherein each double hinge further comprises a first hinge pin pivotally coupled between said fist hinge plate and said pivot plate and a second hinge pin pivotally coupled between said second hinge plate and said pivot plate.

14. A door system for a cargo containment structure of claim 1 wherein said cargo containment structure is a semi-trailer.

15. A door system for a cargo containment structure of claim 7 wherein said cargo containment structure is a semi-trailer.

16. A door system for a cargo containment structure of claim 13 wherein said cargo containment structure is a semi-trailer.
